(19) United States
(12) Patent Application Publication
(10) Pub. No.: US 2013/0290047 A1
(43) Pub. Date: Oct. 31, 2013

(54) FACILITATING ASSESSMENT OF A SERVICE THROUGH USE OF USER ASSIGNED WEIGHTS

(71) Applicants: Cullen E. BASH, Los Gatos, CA (US); Yuan CHEN, Sunnyvale, CA (US); Kiara Groves CORRIGAN, Burlingame, CA (US); Daniel Juergen GMACH, Palo Alto, CA (US); Dejan S. MILOJICIC, Pato Alto, CA (US); Amip J. Shah, Santa Clara, CA (US)

(72) Inventors: Cullen E. BASH, Los Gatos, CA (US); Yuan CHEN, Sunnyvale, CA (US); Kiara Groves CORRIGAN, Burlingame, CA (US); Daniel Juergen GMACH, Palo Alto, CA (US); Dejan S. MILOJICIC, Pato Alto, CA (US); Amip J. Shah, Santa Clara, CA (US)

(21) Appl. No.: 13/460,572

(22) Filed: Apr. 30, 2012

(51) Int. Cl. G06Q 10/06

(52) U.S. Cl. 705/7.11

(57) ABSTRACT

In a method for facilitating assessment of a service, values of a plurality of metrics corresponding to the service are acquired. In addition, weights that a user has respectively assigned to each of the plurality of metrics are acquired and a service-level metric value for the service is calculated through calculation of a function that statistically evaluates the weights respectively assigned to the plurality of metrics and the acquired values of the plurality of metrics.

### CROSS-REFERENCE TO RELATED APPLICATIONS

This application contains some common subject matter with co-pending U.S. patent application Ser. No. 12/824,699, filed on Jun. 28, 2010, titled “Determining Environmental Impact”; PCT Application Serial No. PCT/US2011/54690, filed on Oct. 15, 2011, titled “Service Sustainability Systems and Methods”; PCT Application Serial No. PCT/US2011/56491, filed on Oct. 15, 2011, titled “Quantifying Power Usage for a Service”; U.S. patent application Ser. No. 13/015,501, filed on Jan. 27, 2011, titled “Determining an Entity's Share of Economic Environmental Burden”; and U.S. patent application Ser. No. 13/445,691, filed on Apr. 12, 2012, titled “Estimating a Metric Related to a Service Demand Using a Defined Framework, the disclosures of which are hereby incorporated by reference in their entireties.

### BACKGROUND

There has been increasing interest by service providers, such as information technology service providers, to evaluate the impacts of their activities. Examples of these impacts include carbon emissions, recycling efforts, energy consumption, and water use. In addition, concern over sustainability is also increasing for service providers as a result of increasing demand for services, rising energy costs, regulatory requirements, and social concerns over greenhouse gas emissions.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an electronic apparatus, according to an example of the present disclosure;

FIGS. 2-4, respectively, show flow diagrams of methods for facilitating assessment of a service, according to examples of the present disclosure;

FIG. 5 depicts a diagram of a hierarchy of users, services, classes of services, and a services superset, according to an example of the present disclosure; and

FIG. 6 illustrates a schematic representation of a computing device, which may be employed to perform various functions of the service assessment facilitating apparatus depicted in FIG. 1, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Organizations, such as information technology (IT) service providers and consumers of IT services, are increasingly interested in determining information about various metrics, such as sustainability, power consumption, cost, etc., associated with various services, such as IT services, including, cloud computing, e-mail messaging, etc. In other words, organizations are interested in determining the kind of impact, which is recited herein as a “metric”, that providing and/or receiving a service has on, for instance, the environment generally, energy consumption, resource consumption, carbon dioxide emissions, water use, recycling, operating cost, etc. Determining various metrics of a particular organization, such as a cloud services provider, an internet mail (e-mail) service provider, a data center provider, etc., in providing various IT services, such as cloud computing resources, e-mail service, computing resources, etc., has involved manually determining the services components the organization employs to provide the various services and determining the metrics related to each of the components.

The lower-level metrics, that is, those metrics related to each of the services components, such as servers, networking equipment, virtual machine equipment, power supplies, backup equipment, etc., may be used to determine a higher level metric associated with the services provided by the organization. Thus, for instance, if an organization is known to employ a certain number of services components of particular types, the lower-level metrics of those particular types of services components may be determined and a higher level metric, such as sustainability, may be determined simply by multiplying the number of services components with the lower-level metric values.

Information pertaining to the services components that are employed to provide the services may be gathered from publicly available sources, such as the Internet. As another example, the information may be obtained from privately accessible sources, such as a secure server, or from the organizations that provide the services. In instances where the lower-level metric data is unavailable for the services and services components, various modeling and/or techniques may be employed to determine the lower-level metric data. Various methods for determining the lower-level metric data may be found in co-pending PCT Application Serial Nos. PCT/US2011/56490 and PCT/US2011/56491. According to an example, the services and the services components that are used to deliver the services may be determined, for instance, as described in U.S. patent application Ser. No. 13/445,691.

Multiple metrics for a particular service may be aggregated to determine a single value that describes the particular service. This may be performed for multiple services and the determined values may be compared with each other to determine which of the services has, for instance, the most beneficial metrics. That is, for instance, the service with the lowest (or highest) determined value may be identified as being the most beneficial, for instance, causing the least amount of harm to the environment, consuming the least amount of energy, etc. This manner of comparison among the services, however, does not consider the relative importance of each of the different metrics to users. In other words, for example, the values used to compare the services may not accurately reflect that a user may consider carbon emissions to be more important than energy costs in assessing a service.

Disclosed herein are a method and an apparatus for facilitating assessment of a service, in which the assessment of the service considers how a user rates the importance of multiple metrics on the service. More particularly, respective weights that the user assigns to the different metrics are used to calculate a service-level metric value for the service. This may be performed for a plurality of users to calculate a plurality of service-level metric values for the service. In addition, an overall service-level metric value may be calculated based upon the plurality of service-level metric values. The overall service-level metric value may be re-calculated over a number of iterations to meet a predefined criteria by modifying the set of service-level metric values used to calculate the overall service-level metric value. The determination of the overall service-level metric value is therefore made through implementation of a closed loop system by which subjective weightings of different users are used.

The subjective weightings applied to the services may be expanded to determine class-level metric values and superset-level metric values. In this regard, the overall service-level metric values of a plurality of services may be used to facilitate assessment of a class or classes of services. In addition, assessment of a superset of classes may also be facilitated based upon the overall service-level metric values.

Through implementation of the method and apparatus disclosed herein, the importance that users have applied to various metrics of the services are taken into consideration to generally enable an “apples-to-apples” type of comparison to be performed between services. In other words, the service-level metric values, as well as the class-level metric values and the superset-level metric values, discussed herein enable comparisons to be drawn between services, classes of services, and/or supersets of classes that may more meaningful and/or relevant to a particular user.

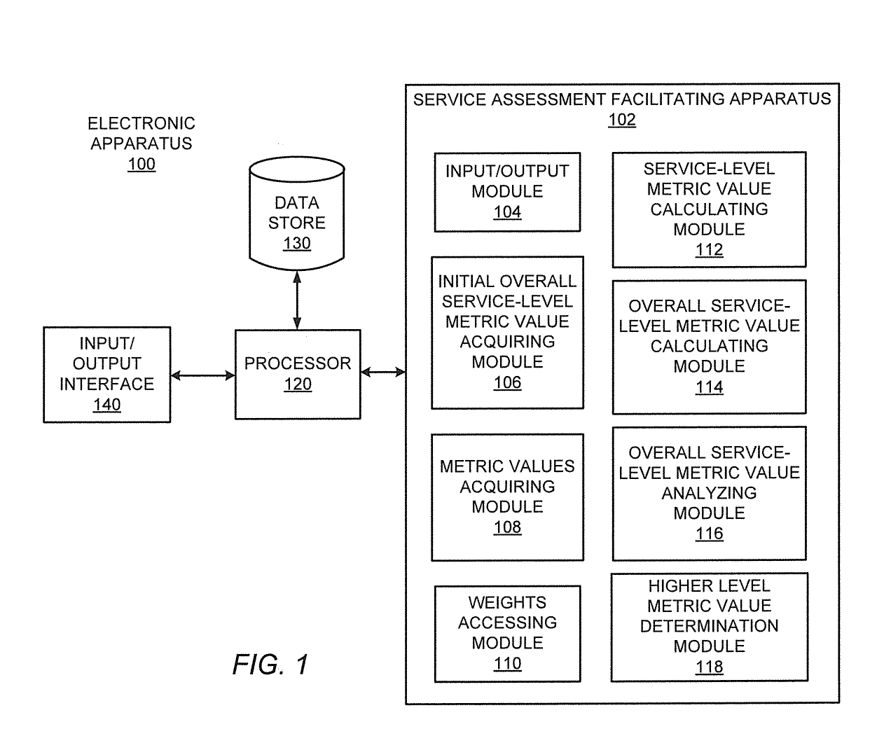

With reference first to FIG. 1, there is shown a block diagram of an electronic apparatus 100, according to an example. It should be understood that the electronic apparatus 100 may include additional components and that one or more of the components described herein may be removed and/or modified without departing from a scope of the electronic apparatus 100.

The electronic apparatus 100 includes a service assessment facilitating apparatus 102, a processor 120, a data store 130, and an input/output interface 140. The electronic apparatus 100 comprises a server, a computer, a laptop computer, a tablet computer, a personal digital assistant, a cellular telephone, or other electronic apparatus that is to perform a method for facilitating assessment of a service.

The service assessment facilitating apparatus 102 is depicted as including an input/output module 104, an initial overall service-level metric value acquiring module 106, a metric values acquiring module 108, a weights accessing module 110, a service-level metric value calculating module 112, an overall service-level metric value calculating module 114, an overall service-level metric value analyzing module 116, and a higher level metric value determination module 118. The processor 120, which may comprise a microprocessor, a micro-controller, an application specific integrated circuit (ASIC), and the like, is to perform various processing functions in the electronic apparatus 100. One of the processing functions includes invoking or implementing the modules 104-118 as discussed in greater detail herein below.

According to an example, the service assessment facilitating apparatus 102 comprises a hardware device, such as a circuit or multiple circuits arranged on a board. In this example, the modules 104-118 comprise circuit components or individual circuits. According to another example, the service assessment facilitating apparatus 102 comprises a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 104-118 comprise software modules stored in the service assessment facilitating apparatus 102. According to a further example, the modules 104-118 comprise a combination of hardware and software modules.

The input/output interface 140 may comprise a hardware and/or a software interface. In any regard, the input/output interface 140 may be connected to a network, such as the Internet, an intranet, etc., over which the service assessment facilitating apparatus 102 may receive data. The processor 120 may store data received through the input/output interface 140 in the data store 130 and may use the data in implementing the modules 104-118. The data store 130 comprises volatile and/or non-volatile memory, such as DRAM, EEPROM, MRAM, phase change RAM (PCRAM), Memristor, flash memory, and the like. In addition, or alternatively, the data store 130 comprises a device that is to read from and write to a removable media, such as a floppy disk, a CD-ROM, a DVD-ROM, or other optical or magnetic media.

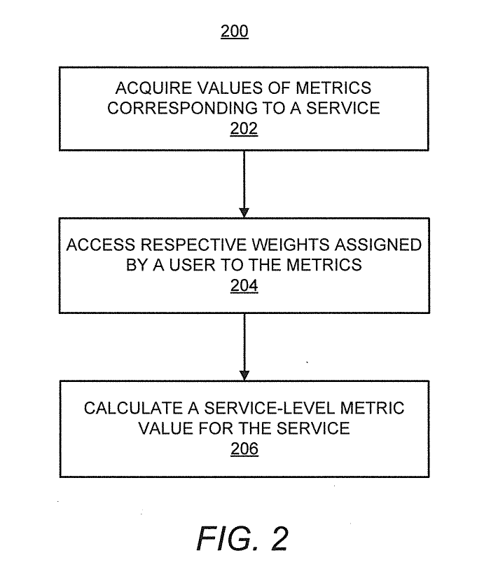

Various manners in which the modules 104-118 of the service assessment facilitating apparatus 102 may be implemented are discussed in greater detail with respect to the methods 200-400 respectively depicted in FIGS. 2-4. FIGS. 2-4, more particularly, respectively depict flow diagrams of methods 200, 300, and 400 for facilitating assessment of a service, according to three examples. It should be apparent to those of ordinary skill in the art that the methods 200-400 represent generalized illustrations and that other steps may be added or existing steps may be removed, modified or rearranged without departing from the scopes of the methods 200-400. Although particular reference is made to the service assessment facilitating apparatus 102 depicted in FIG. 1 as comprising an apparatus and/or a set of machine readable instructions that may perform the operations described in the methods 200-400, it should be understood that differently configured apparatuses and/or machine readable instructions may perform the methods 200-400 without departing from the scopes of the methods 200-400.

Generally speaking, the method 200 may be implemented to facilitate assessment of a service. The method 300 may include the features of the method 200 and may be implemented to refine an overall service-level metric value of the service. In addition, the method 400 may include the features of the methods 200 and 300 and may further be implemented to facilitate assessment of a class of services, and/or a superset of classes. More particularly, the methods 200, 300, and 400 may be independently implemented to facilitate assessment of a service, a class of services, and/or a superset of classes based upon the relative importance that a user, or a group of users, has assigned to a plurality of metrics. As discussed above, the metrics may comprise at least one of, for instance, carbon dioxide emissions, water use, recycling, operating cost, etc., corresponding to a service. In this regard, the service may be assessed based upon subjective weightings that indicate the importance that the user(s) have placed on different metrics. The subjective weightings applied to a plurality of services may be expanded to facilitate assessment of a class or classes of services. In addition, assessment of a superset of classes may also be facilitated based upon an evaluation of the subjective weightings applied to the plurality of services. In one regard, therefore, through implementation of the methods 200-400 disclosed herein, assessment of classes of services and/or supersets of classes may be facilitated through assessment of user-weighted metrics at the service level.

According to an example, the weighting definitions applied by the users are iterated to avail a standardized definition for a consensus-driven metric that may be cascaded across the services, classes of services, and superset of classes. There are two approaches for this. One approach is a top-down approach, where the overall service-level metric, which is weighted based upon the user inputs, is cascaded across all services and users regardless of any discrepancy between individual metrics at each class and the overall service level metric. In other words, for instance, in the top-down approach, the discrepancy between a user and a class may be disregarded and all of the users may initially be treated equally. Another approach is a bottom-up approach, where sets of metrics are compared at each level of the hierarchy and a choice is made around which set to use. For example, at the level of a single service, a weighted user-average for the service, the overall service-level metric, or some combination of the two may be used. Once this choice is made, it becomes the representative metric for use within other levels of the hierarchy. Thus, for instance, one possible solution is selected on how to determine the metrics for a superset of classes and that selected solution is applied to the classes in the superset of classes.

This type of an approach would be iterative, requiring some type of threshold definitions to ensure convergence as discussed below. However, this type of approach may eventually yield a more accurate representation of metric definitions at each class and at the superset of classes. This convergence may be based on either a threshold delta between the initial value at the start of the iteration and the final value at the end of an iteration, or simply based on the number of iterations, as also discussed below.

At block 202, values of a plurality of metrics corresponding to a service are acquired, for instance, by the metric values acquiring module 108. The metric values may comprise the actual or estimated values of the metrics corresponding to services components implemented to provide/perform the service. As discussed above, the services components corresponding to the service as well as the metric values may be acquired through any of a variety of manners. For instance, the values of the metrics may be obtained from a database that includes the values of the metrics for the components that are implemented to provide the service. As another example, the metric values may be determined through any of the various methods described in PCT Application Serial Nos. PCT/US2011/56490 and PCT/US2011/56491. In addition, or alternatively, the metric values may be estimated through any of the methods described in co-pending U.S. patent application Ser. No. 13/445,691.

At block 204, respective weights that a user has assigned to each of the plurality of metrics corresponding to the service are accessed, for instance, by the weights accessing module 110. Alternatively, respective weights that a plurality of users have assigned to each of the plurality of metrics corresponding to the service are accessed. More particularly, for instance, the user(s) of the service, e.g., the end users of the service, administrators of the service components associated with the service, clients of the service providers, etc., may be polled to determine their preferred weightings for the metrics corresponding to the service. In other words, a request may be made to the users of the service as to the relative importance each of the metrics corresponding to the service has to the users. The users may provide their weightings through any reasonably suitable medium, such as for instance, a web portal, via email, via the postal service, in person, or through any other suitable communication mechanism. In addition, the weightings may either comprise weightings between 0 to 100% for each of the metrics or the weightings may be scaled such that the totals for the weightings equal 100%. Alternatively, however, any other suitable weighting scheme may be employed.

According to an example, the weightings assigned to each of the metrics corresponding to the service or a plurality of services may be stored in the data store 130 or other location and the weights accessing module 110 may access the weightings from their stored locations. Alternatively, the weights accessing module 110 may directly receive the weightings from the users or other from other sources.

By way of example, for a particular service, a user may assign a fifty percent weighting to energy consumption, a forty percent weighting to carbon emissions, and a ten percent weighting to water use. In this regard, to the user, energy consumption is the most important, while water use is the least important.

At block 206, a service-level metric value for the service is calculated, for instance, by the service-level metric calculating module 112. More particularly, the service-level metric value for the service is calculated through calculation of a function that statistically evaluates the weights respectively assigned to the plurality of metrics and the acquired values of the plurality of metrics. According to an example, the service-level metric value (I) for the user is calculated through the calculation of:

I=w₁*I₁+w₂*I₂+ . . . +wₙ*Iₙ, Equation (1)

in which I₁, I₂, . . . , Iₙ are the plurality of metrics and w₁, w₂, . . . , wₙ are weighting coefficients corresponding to the weights that the at least one user has respectively assigned to each of the plurality of metrics I₁, I₂, . . . , Iₙ. In addition, n is the total number of the metrics corresponding to the service, for instance, for which values have been acquired at block 202. In addition, or alternatively, n is the total number of metrics that are to be used in assessing the service, for instance, as designated by an administrator of the method 200.

According to an example, each of the metric values I₁, I₂, . . . , Iₙ in Equation (1) may be normalized to enable the terms to be summed together. The metric values I₁, I₂, . . . , Iₙ may be normalized in any of a plurality of suitable manners to enable each of the metric values to have the same units or to be dimensionless. By way of particular example, each of the metrics may be normalized to a per-capita representation of the metric as described in the article titled “Impact 2002+: A new Life Cycle Impact Assessment Methodology” by Olivier Jolliet et al., the disclosure of which is hereby incorporated by reference in its entirety.

By way of example, a user may care about carbon emissions only and not care about any other metric. For this user, w₁=1 and (w₂, . . . , wₙ)=0. As another example, another user may care equally about water use and carbon emissions, and not about anything else. For this user, w₁=0.5 and w₂=0.5 and (w₃, . . . , wₙ)=0. As a further example, another user may care equally about all the metrics. For this user, the weightings for each coefficient wᵢ=1/n.

According to an example, and as discussed in greater detail herein, the service-level metric value for the service calculated at block 206 may be used to compare the service with other services. In this example, the method 200 may be implemented to calculate the service-level metric values of a plurality of services, for instance, the services in a particular class of services, and service-level metric values may be compared with each other to determine which of the services best correlates with the metrics that are most important to a particular user or to a group of users. Thus, although a particular service may generally have a higher service-level metric value that may change when individual user weightings are considered in the determination of the service-level metric value through implementation of the method 200.

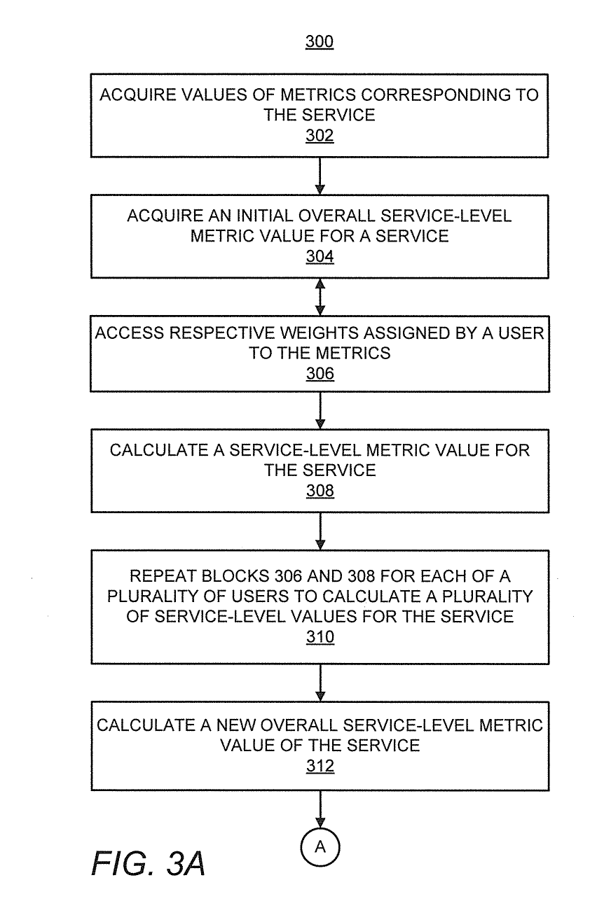

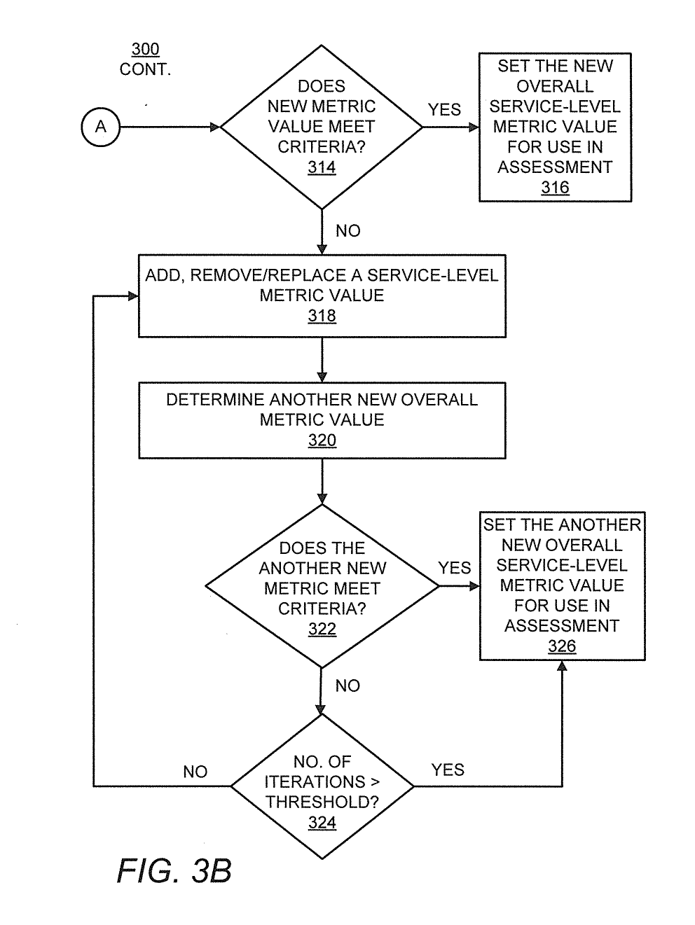

Turning now to FIGS. 3A and 3B, the method 300 generally comprises the operations implemented in the method 200, but contains additional operations. In one regard, however, the method 300 differs from the method 200 in that a number of iterations of the service-level metric values may be performed to more accurately correlate the service-level metric values of services to the subjective weightings assigned to the metrics corresponding to the services.

At block 302, values of a plurality of metrics corresponding to a service are acquired, for instance, by the metric values acquiring module 108 as described above with respect to block 202 in FIG. 2.

At block 304, an initial overall service-level metric value for the service is acquired, for instance, by the initial overall service-level value acquiring module 106. The initial overall service-level metric value for a service may comprise, for instance, a value corresponding to the metrics of the service. Thus, for instance, the initial overall service-level metric value for the service may comprise a value that is obtained through calculation of a function that statistically evaluates a plurality of metrics corresponding to the service. By way of particular example, the metrics corresponding to the service may be added together, multiplied together, etc. As discussed above, the values of the plurality of metrics may be normalized to determine the initial overall service-level metric value. The values for the metrics as well as the components corresponding to the service may be determined in any of the manners discussed above with respect to the method 200. In addition, or alternatively, the initial overall service-level value for the service may have previously been determined and stored, for instance, in the data store 130 or other storage location, and may thus be retrieved for its stored location. In the absence of a value for the initial overall service-level value, the initial overall service-level value may be set as zero. In this regard, the acquiring of the initial overall service-level value at block 304 may be considered as optional.

At block 306, respective weights that a plurality of users have assigned to each of the plurality of metrics corresponding to the service are accessed, for instance, by the weights accessing module 110, as described above with respect to block 204 in FIG. 2.

At block 308, a service-level metric value for the service is calculated, for instance, by the service-level metric calculating module 112, as described above with respect to block 206 in FIG. 2.

At block 310, blocks 306 and 308 are repeated for each of a plurality of users to calculate a plurality of service-level evaluation values for the service corresponding to the plurality of users.

At block 312, a new overall service-level metric value of the service is calculated, for instance, by the overall service-level metric value calculating module 114. The new overall service-level metric value may be calculated through calculation of a second function that statistically evaluates the plurality of service-level metric values for the service corresponding to the plurality of users calculated at block 310. By way of example, the new overall service-level metric value of the service is calculated by calculating an average of the plurality of service-level metric values corresponding to the plurality of users.

According to an example, the new overall service-level metric value of the service calculated at block 312 is set for use in assessing the service. In other words, the new overall service-level metric value calculated at block 312 may be used in comparing the service with other services. In this regard, the method 300 may end at block 312.

In another example, however, at block 314, a determination as to whether the new overall service-level metric value of the service meets a predetermined criteria is made, for instance, by the overall service-level metric value analyzing module 116. In this example, the determination at block 314 may be made in response to a change in the service-level metric values that causes a change in the overall service-level metric value. This may occur, for instance, when a new user submits their weightings, as a demographic of the users changes, etc.

According to an example, the predetermined criteria comprises a percentage change in the new overall service-level metric value from a prior overall service-level metric value. Thus, for instance, if the percentage change is below a predefined threshold, then the prior overall service-level metric value is maintained as the overall service-level metric value. However, if the percentage change is above the predefined threshold, then the new overall service-level metric value is set as the overall service-level metric value for use in assessment of the service at block 316. The predefined threshold may be determined based upon any suitable factors, for instance, the predefined threshold may be set to a lower value in instances where calculation of class-level evaluation values is lower or when there are a relatively large number of service-level metric values. By way of particular example and not of limitation, the predefined threshold may range from about 1% to 20% or more.

In one regard, the determination at block 314 is made to substantially ensure that relatively minor changes in the service-level evaluation values do not cause the overall service-level metric value to be modified. In addition, the determination is made to substantially ensure that the relatively minor changes are not propagated through the class-level metric values or the superset-level metric values, as updating these values consume resources.

According to an example, the determination at block 314 comprises a determination as to whether a difference between the new overall service-level metric value and the initial overall service-level metric value, for instance, acquired at block 304, falls below the predefined threshold.

In response to a determination that the new overall service-level metric value meets the predetermined criteria, for instance, that the difference between the new overall service-level metric value and the initial overall service-level metric value falls below the predefined threshold, the new overall service-level metric value is set for use in assessment of the service, as indicated at block 316. That is, for instance, a user may use the new overall service-level metric value in comparing the service to another service, instead of using the initial or a prior calculated overall service-level metric value to make this comparison.

However, in response to a determination that the new overall service-level metric value fails to meet the predetermined criteria, at block 318, the service-level metric value used to calculate the new overall service-level metric value is replaced and/or removed, for instance, by the overall service-level metric value calculating module 114. That is, for instance, a service-level metric value is added, replaced and/or removed in response to a determination that the difference between the new overall service-level metric value and the initial overall service-level metric value falls below the predetermined threshold. The determination as to whether a service-level metric value is to be added or which of the service-level metric values is to be replaced and/or removed may be made based upon any of a plurality of decision factors. For instance, the service-level metric value with the highest discrepancy from an average of the service-level metric values may be selected for replacement and/or removal. As another example, a service-level metric value corresponding to a particular user or to a particular type of user may be selected for removal. As a further example, a service-level metric value corresponding to a particular type of user may be selected for replacement with a service-level metric value corresponding to another particular type of user. As a yet further example, a service-level metric value may randomly be selected for replacement and/or removal.

At block 320, another new overall service metric value is determined, for instance, by the overall service-level metric value calculating module 114. The another new overall service metric value is determined with the service-level metric value removed and/or replaced at block 318 in any of the manners discussed above with respect to block 312.

At block 322, a determination as to whether the another new overall service-level metric value of the service meets a predetermined criteria is made, for instance, by the overall service-level metric value analyzing module 116. This determination may be made as discussed above with respect to block 314.

According to an example, at block 322, the determination comprises a determination as to whether a difference between the another new overall service-level metric value and the initial overall service-level metric value, for instance, acquired at block 304, exceeds the predefined threshold.

In response to a determination that the another new overall service-level metric value meets the predetermined criteria, for instance, that the difference between the another new overall service-level metric value and the initial overall service-level metric value exceeds the predefined threshold, the another new overall service-level metric value is set for use in assessment of the service, as indicated at block 326.

However, in response to the determination that the new overall service-level metric value fails to meet the predetermined criteria, at block 324, a determination is made as to whether a number of iterations over which blocks 318-322 have been performed exceeds a predefined iteration threshold. The predefined iteration threshold may comprise any suitable number of iterations and may be user-defined. The criteria used to set the predefined iteration threshold include, for instance, the desired time to convergence and/or computational considerations, such as available memory and associated computational costs, defined proportionally to the number of users from whom data is being procured, etc. In addition, or alternatively, the predefined iteration threshold may be determined to have been met when a difference between two iterations is smaller than a specified threshold, e.g., sufficiently small.

In response to a determination that the number of iterations exceeds the predefined iteration threshold, the another new overall service-level metric value is set for use in assessment of the service, as indicated at block 326. In response to a determination that the number of iterations falls below the predefined iteration threshold, another service-level metric value used to calculate the another new overall service-level metric value is added, removed and/or replaced as indicated at block 318, for instance, by the overall service-level metric value calculating module 114. The determination as to whether the another service-level metric value is to be added or which of the service-level metric values is to be replaced and/or removed may be made based upon any of a plurality of decision factors as discussed above.

In addition, blocks 320-324 may be repeated until the “yes” condition is reached at either of blocks 322 and 324.

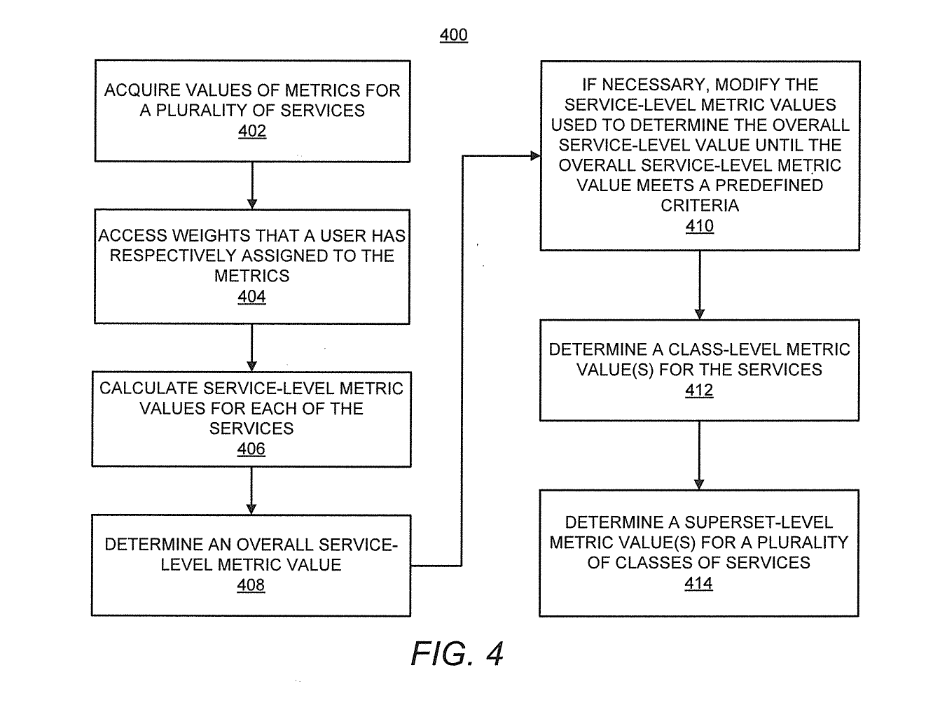

Although the method 300 has been depicted and described with respect to a single service, it should be clearly understood that the method 300 may be implemented with respect to multiple services. An example of a manner in which the method 300 may be extended to multiple services is described with respect to FIG. 4, which also shows a method 400 for facilitating assessment of a service, according to another example.

At block 402, values of a plurality of metrics corresponding to a plurality of services are acquired, for instance, by the metric values acquiring module 108. The values of the metrics corresponding to the plurality of services may be acquired in any of the matters described above with respect to block 202 in FIG. 2.

At block 404, respective weights that a user has assigned to each of the plurality of metrics corresponding to the plurality of services are accessed, for instance, by the weights accessing module 110. Alternatively, respective weights that a plurality of users have assigned to each of the plurality of metrics corresponding to the services are accessed. The weights assigned by the user(s) may be accessed in any of the manners discussed above with respect to block 204 in FIG. 2.

At block 406, service-level metric values for the plurality of services, in which each of the plurality of service-level metric values corresponds to a particular service in the plurality of services, for instance, by the service-level metric value calculating module 112. The service-level metric values may be calculated in any of the manners discussed above with respect to block 206 in FIG. 2.

At block 408, an overall service-level metric value for each of the plurality of services is calculated, for instance, by the overall service-level metric value calculating module 114. As discussed above with respect to block 312 in FIG. 3A, each of the overall service-level metric values may be calculated through calculation of a second function that statistically evaluates the plurality of service-level metric values for the service corresponding to the plurality of users calculated at block 310. By way of example, the overall service-level metric value of a particular service is calculated by calculating an average of the plurality of service-level metric values corresponding to the plurality of users for that particular service.

At block 410, if necessary, the service-level metric values used to determine the overall service-level evaluation value are modified until the overall service-level metric value meets a predetermined criteria, for instance, by the overall service-level metric value analyzing module 116. Block 410 is considered to be optional because the overall service-level metric value calculated at block 408 may already meet the predetermined criteria and thus block 410 need not be performed. In any regard, block 410 is similar to blocks 314-326 in FIG. 3B. In this regard, following performance of block 410, an overall service-level metric value that substantially accurately reflects the weights assigned by a plurality of users to the services from which the overall service-level metric value is calculated may be set.

At block 412, a class-level metric value for a plurality of services is determined, for instance, by the higher level metric value determination module 118. Alternatively, a plurality of class-level metric values may be determined for respective sets of a plurality of services, for instance, the class-level metric value for a set of a plurality of services comprises a class-level metric value for a plurality of services that are in the same class of services. In any regard, the class-level metric value for the services in a particular class of services may be determined as a function of the respective overall service-level metric values of the services in the particular class of services. By way of example, the class-level metric value for the services in the particular class of services may comprise a statistical average value of the overall service-level metric values of the services in the particular class of services. As another example, the class-level metric value for the services in the particular class of services may comprise a value of the overall service-level metric values of the services weighted in a predefined manner. For instance, certain ones of the services in a particular class may be considered as having a greater importance than other ones of the services in the particular class and thus, those services identified as having greater importance may have higher weighting. The weightings may also be user-defined in any of the manners discussed above with respect to the method 200 and 300.

At block 414, a superset-level metric value for a plurality of classes is determined, for instance, by the higher level metric value determination module 118. Alternatively, a plurality of superset-level metric values may be determined for respective sets of a plurality of classes, for instance, the superset-level metric value for a set of a plurality of classes comprises a superset-level metric value for a plurality of classes that are in the same superset. In any regard, the superset-level metric value for the classes in a particular superset of classes may be determined as a function of the respective class-level metric values of the classes in the particular superset of classes. By way of example, the superset-level metric value for the classes in the particular superset of services may comprise a statistical average value of the class-level metric values of the classes in the particular superset of services. As another example, the superset-level metric value for the classes in the particular superset of classes may comprise a value of the class-level metric values of the classes weighted in a predefined manner. For instance, certain ones of the classes in a particular superset of classes may be considered as having a greater importance than other ones of the classes in the particular superset and thus, those classes identified as having greater importance may have higher weighting. The weightings may also be user-defined in any of the manners discussed above with respect to the services.

Although the method 400 has been described with respect to a plurality of classes and a superset of classes, it should be understood that the hierarchy of the services, classes, and supersets may include additional levels without departing from a scope of the method 400.

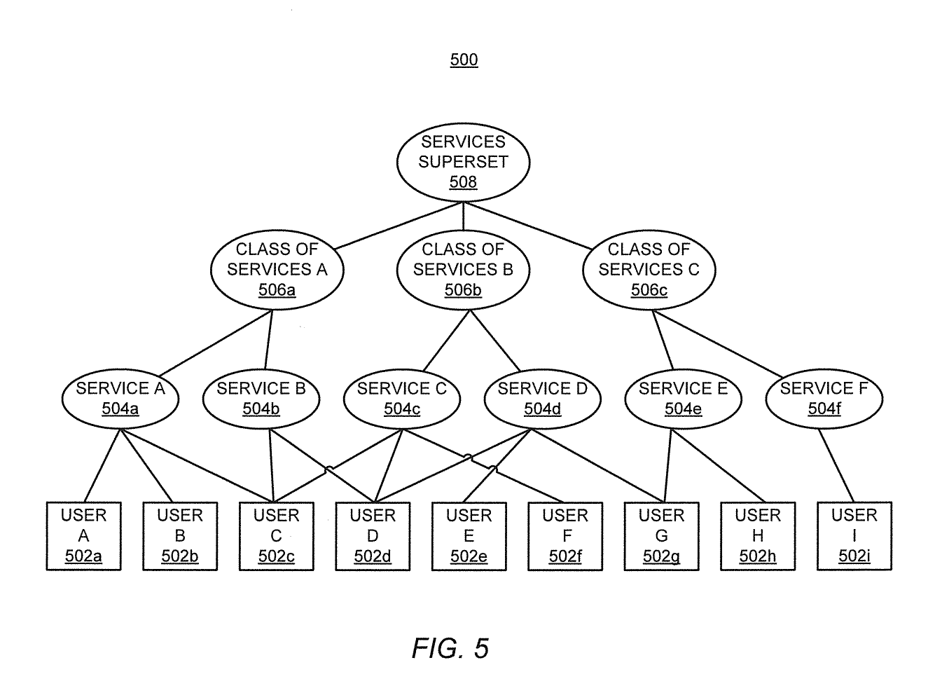

With reference now to FIG. 5, there is shown a diagram 500 of a hierarchy of users 502a-502i, services 504a-504f, classes of services 506a-506c, and a services superset 508, according to an example. As shown therein, the users 502a-502i represent, for instance, end users of the respective services 504a-504i. In this regard, users 502a-502c may represent the end users of a first service 504a and thus may represent the users from which weights have been assigned to the first service 504a may be acquired. Likewise, the users 502c and 502d may represent the end users of a second service 504b from which weights have been assigned to the second service 504b may be acquired, and so forth. In this regard, overall service-level metric values for each of the services 504a-504f may be determined through implementation of any of the methods 200-400 discussed above.

In addition, class-level metric values for each of the classes of services 506a-506c may be determined as discussed above with respect to the method 400. Moreover, a superset-level metric value for these services superset 508 may also be determined as discussed above with respect to the method 400. As also shown therein, each of the classes of services 506a-506c is associated with respective sets of services 504a-504f and the services superset 508 is associated with the classes of services 506a-506c. By way of particular example, each of the services 504a-504f comprises a different type of service, such as a service performed by a particular type of server or other services component. In this example, the classes of services 506a-506c may each comprise a different type of email service that uses different ones or combinations of the services 504a-504f in providing the email services. In addition, the services superset 508 may comprise a plurality of email services. As another particular example, the classes of services 506a-506c may each comprise a different type of online retail service and the services superset 508 may comprise a plurality of online retail services. In this example, the services superset 508 for the email services may be compared with the services superset 508 for the online retail services to determine which one of these types of businesses may better suit a particular user.

According to another example, the services 504a-504f comprises different types of web-based services, such as Hotmail™, Yahoo Email™, Gmail™, Twitter™, Linkedin™, Facebook™, Google™, Microsoft Bing™, Amazon™, Walmart™, etc. In this example, the next level are different classes of services 506a-506c, for instance, an email service class, which may include email service providers, such as Gmail™, Yahoo Email™, Hotmail™, etc., a social network service class, which may include social networking service providers, such as Facebook™, Linkedin™, Twitter™, etc., an online shopping service class, which may include online shopping service providers, such as Amazon™, Walmart™, etc., and an online search service class, which may include online search service providers, such as Google™, Microsoft Bing™, etc. An example of a superset class 508 may comprise an online web service, including all of the different classes of services 506a-506c, which may include the email service class, the social network service class, etc. An example of another superset class 508 may comprise a superset of classes for other IT services, e.g., non web applications. The hierarchy depicted in FIG. 5 may further be expanded to include another superset of a plurality of services supersets 508, and so forth. In this regard, the height of the hierarchy in the diagram 500 may vary.

According to an example, the service-level metric values for the services 504a-504f may be used to assess the services 504a-504f with respect to each other. Likewise, the class-level metric values for the classes of services 506a-506c may be used to assess the classes of services 506a-506c with respect to each other. Furthermore, the superset-level metric value for the services superset 508 may be used to assess the services superset 508 with respect to other services superset, and so forth.

Generally speaking, therefore, the service-level metric values for the services 504a-504f enable an “apples-to-apples” type of comparison to be performed between services, in which the importance that users have applied to various metrics of the services are taken into consideration. In other words, the service-level metric values, as well as the class-level metric values and the superset-level metric values, discussed herein enable comparisons to be drawn between services, classes of services, and/or supersets of classes that may be relatively more meaningful and/or relevant to a particular user. In one regard, therefore a user may choose to provide and/or receive a particular service over another service based upon a comparison of the service-level metric values associated with the services, in which, the comparison factors their subjective weightings applied to various metrics.

Some or all of the operations set forth in the methods 200-400 may be contained as a utility, program, or subprogram, in any desired computer accessible medium. In addition, the methods 200-400 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

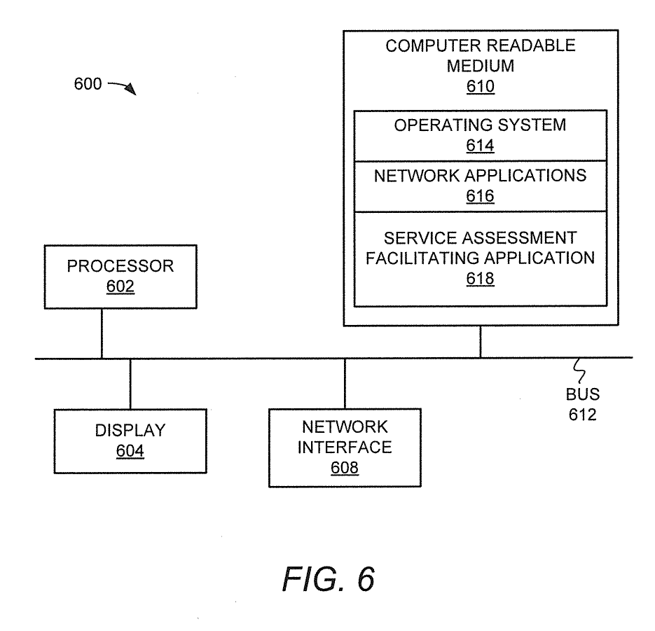

Turning now to FIG. 6, there is shown a schematic representation of a computing device 600, which may be employed to perform various functions of the service assessment facilitating apparatus 102 depicted in FIG. 1, according to an example. The computing device 600 includes a processor 602, such as but not limited to a central processing unit; a display device 604, such as but not limited to a monitor; a network interface 608, such as but not limited to a Local Area Network LAN, a wireless 802.11x LAN, a 3G mobile WAN or a WiMax WAN; and a computer-readable medium 610. Each of these components is operatively coupled to a bus 612. For example, the bus 612 may be an EISA, a PCI, a USB, a FireWire, a NuBus, or a PDS.

The computer readable medium 610 comprises any suitable medium that participates in providing instructions to the processor 602 for execution. For example, the computer readable medium 610 may be non-volatile media, such as memory. The computer-readable medium 610 may also store an operating system 614, such as but not limited to Mac OS, MS Windows, Unix, or Linux; network applications 616; and a service assessment facilitating application 618. The operating system 614 may be multi-user, multiprocessing, multitasking, multithreading, real-time and the like. The operating system 614 may also perform basic tasks such as but not limited to recognizing input from input devices, such as but not limited to a keyboard or a keypad; sending output to the display 604; keeping track of files and directories on medium 610; controlling peripheral devices, such as but not limited to disk drives, printers, image capture device; and managing traffic on the bus 612. The network applications 616 include various components for establishing and maintaining network connections, such as but not limited to machine readable instructions for implementing communication protocols including TCP/IP, HTTP, Ethernet, USB, and FireWire.

The service assessment facilitating application 618 provides various components for facilitating assessment of a service as discussed above with respect to the methods 200-400. The service assessment facilitating application 618 may thus comprise the input/output module 104, the initial overall service-level metric value acquiring module 106, the metric values acquiring module 108, the weights accessing module 110, the service-level metric value calculating module 112, the overall service-level metric value calculating module 114, the overall service-level metric value analyzing module 116, and the higher level metric value determination module 118. In this regard, the service assessment facilitating application 618 may include a module(s) for acquiring values of a plurality of metrics corresponding to the a service,’ accessing weights that a plurality of users have respectively assigned to each of the plurality of metrics, calculating a plurality of service-level metric values for the service, wherein each of the plurality of service-level metric values are calculated through calculation of a function that statistically evaluates the weights respectively assigned to the plurality of metrics and the acquired values of the plurality of metrics by a user of the plurality of users, and determining an overall service-level metric value for the service through calculation of a second function that statistically evaluates the plurality of service-level metric values for the service. The service assessment facilitating application 618 may also include a module(s) for iteratively adding, removing, or replacing the plurality of service-level metric values and re-calculating the overall service-level metric value for the service until the overall service-level metric value is determined to meet the predetermined criteria. The service assessment facilitating application 618 may further include a module(s) for determining a plurality of class-level metric values from the plurality of service-level metric values of the plurality of services in the plurality of classes of services and determining a superset-level metric value from the plurality of class-level metric values.

In certain examples, some or all of the processes performed by the application 618 may be integrated into the operating system 614. In certain examples, the processes may be at least partially implemented in digital electronic circuitry, or in computer hardware, machine readable instructions (including firmware and software), or in any combination thereof, as also discussed above.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A method for facilitating assessment of a service, said method comprising:
a) acquiring, by a processor, values of a plurality of metrics corresponding to the service, wherein the plurality of metrics comprise at least two of energy consumption, resource consumption, carbon dioxide emissions, water use, recycling, and operating cost;
b) accessing, by the processor, weights that a user has respectively assigned to each metric of the plurality of metrics; and
c) calculating, by the processor, a service-level metric value for the service through calculation of a function that statistically evaluates the weights respectively assigned to the plurality of metrics and the acquired values of the plurality of metrics.

2. The method according to claim 1, wherein c) further comprises calculating the service-level metric value (I) for the user through calculation of:
I=w₁*I₁+w₂*I₂+ . . . +wₙ*Iₙ, Equation (1)
wherein I₁, I₂, . . . , Iₙ are the plurality of metrics and w₁, w₂, . . . , wₙ are weighting coefficients corresponding to the weights that the user has respectively assigned to each of the plurality of metrics I₁, I₂, . . . , Iₙ.

3. The method according to claim 1, further comprising:
d) repeating a)-c) for a plurality of users to calculate a plurality of service-level metric values for the service corresponding to the plurality of users.

4. The method according to claim 3, further comprising:
e) determining a new overall service-level metric value for the service through calculation of a second function that statistically evaluates the plurality of service-level metric values for the service corresponding to the plurality of users calculated at d);
f) determining whether the new overall service-level metric value meets a predetermined criteria; and
g) setting the new overall service-level metric value for use in assessment of the service in response to the new overall service-level metric meeting the predetermined criteria.

5. The method according to claim 4, further comprising
acquiring an initial overall service-level metric value for the service; and
wherein determining whether the new overall service-level metric value meets the predetermined criteria further comprises determining whether a difference between the new overall service-level metric value and the initial overall service-level metric value exceeds a predetermined threshold.

6. The method according to claim 4, further comprising:
h) in response to a determination that the new overall service-level metric value does not meet the predetermined criteria;
i) at least one of adding, removing, and replacing a service-level metric value of the plurality of service-level metric values for the service;
j) determining another new overall service-level metric value for the service through calculation of the second function with the service-level metric removed from the calculation;
k) determining whether the another new overall service-level metric value meets the predetermined criteria; and
l) setting the another new overall service-level metric value for use in assessment of the service in response to the another new overall service-level metric meeting the predetermined criteria.

7. The method according to claim 6, further comprising:
m) determining whether a number of iterations of i)-k) exceeds a predefined iteration threshold in response to a determination that the new overall service-level metric value does not meet the predetermined criteria at k); and
wherein i) further comprises at least one adding, removing, and replacing the service-level metric value in response to the number of iterations of i)-k) falling below the predefined iteration threshold; and
setting the another new overall service-level metric value for use in assessment of the service in response to the number of iterations of i)-k) meeting the predefined iteration threshold.

8. The method according to claim 1, further comprising:
acquiring values of a plurality of metrics corresponding to a plurality of services;
accessing weights that a user has respectively assigned to each of the plurality of metrics corresponding to the plurality of services; and
calculating a plurality of service-level metric values for the plurality of services, wherein each of the plurality of service-level metric values corresponds to a particular service in the plurality of services.

9. The method according to claim 8, wherein the plurality of services are part of a class of services, said method further comprising:
determining a class-level metric value from the plurality of service-level metric values of the plurality of services in the class of services.

10. The method according to claim 9, wherein the plurality of services are part of a plurality of classes of services, said method further comprising:
determining a plurality of class-level metric values from the plurality of service-level metric values of the plurality of services in the plurality of classes of services; and
determining a superset-level metric value from the plurality of class-level metric values.

11. An electronic apparatus for facilitating assessment of a service, said electronic apparatus comprising:
processor; and
a memory on which is stored machine-readable instructions that when executed by the processor, cause the processor to:
acquire values of a plurality of metrics corresponding to the service, wherein the plurality of metrics comprise at least two of energy consumption, resource consumption, carbon dioxide emissions, water use, recycling, and operating cost;
access weights that a plurality of users have respectively assigned to each of the plurality of metrics;
calculate a plurality of service-level metric values for the service, wherein each of the plurality of service-level metric values is calculated through calculation of a function that statistically evaluates the weights respectively assigned to the plurality of metrics and the acquired values of the plurality of metrics by a user of the plurality of users; and
determine an overall service-level metric value for the service through calculation of a second function that statistically evaluates the plurality of service-level metric values for the service.

12. The apparatus according to claim 11, wherein the machine-readable instructions are to further cause the processor to:
determine whether the overall service-level metric value meets a predetermined criteria; and
set the overall service-level metric value for use in assessment of the service in response to the new overall service-level metric meeting the predetermined criteria.

13. The apparatus according to claim 12, wherein the machine-readable instructions are to further cause the processor to:
iteratively add, remove, or replace the plurality of service-level metric values; and
re-calculate the overall service-level metric value for the service until the overall service-level metric value is determined to meet the predetermined criteria.

14. The apparatus according to claim 11, wherein the machine-readable instructions are to further cause the processor to:
acquire values of a plurality of metrics corresponding to a plurality of services;
access weights that a user has respectively assigned to each of the plurality of metrics corresponding to the plurality of services; and
calculate a plurality of service-level metric values, wherein each of the plurality of service-level metric values corresponds to a particular service in the plurality of services.

15. A non-transitory computer readable storage medium on which is stored a set of machine readable instructions that when executed by a processor cause the processor to:
acquire values of a plurality of metrics corresponding to a service, wherein the plurality of metrics comprise at least two of energy consumption, resource consumption, carbon dioxide emissions, water use, recycling, and operating cost;
access weights that a plurality of users have respectively assigned to each of the plurality of metrics;
calculate a plurality of service-level metric values for the service, wherein each of the plurality of service-level metric values is calculated through calculation of a function that statistically evaluates the weights respectively assigned to the plurality of metrics and the acquired values of the plurality of metrics by a user of the plurality of users; and
determine an overall service-level metric value for the service through calculation of a second function that statistically evaluates the plurality of service-level metric values for the service.
